(19) United States
(12) Patent Application Publication
(10) Pub. No.: US 2006/0139661 A1
(43) Pub. Date: Jun. 29, 2006

(54) Information processing apparatus, computer program product, computer media and method for setting and naming image processing functions

(76) Inventor: Hiroya Kumashio, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/289,480

(22) Filed: Nov. 30, 2005

(30) Foreign Application Priority Data
Nov. 30, 2004 (JP) 2004-347043
Nov. 24, 2005 (JP) 2005-338558

(51) Int. Cl. G06F 3/12

(52) U.S. Cl. 358/1.1; 358/448; 358/442

(57) ABSTRACT

A method, device and computer program product for controlling an information apparatus configured to set a plurality of image processing functions. The method, device and computer program product automatically generate a name of a symbol corresponding to image processing function settings selected from the plurality of image processing functions by a user and set by the user in a display. The automatically generated name is associated with the image processing function settings set by the user. The symbol and automatically generated name are displayed.

### BACKGROUND OF THE INVENTION

1. Field of the Invention

The present invention generally relates to an information processing apparatus, computer program product, computer media and method for setting and naming image processing functions.

2. Description of the Related Art

With the advent of multi-functional printers, a wide variety of print functions (such as combining printing, two-sided printing, stapling, punching and the like) have been made available to users to select and/or control. Setting of these print functions enables wide variety of print functions. On the other hand, the wide variety of print functions makes the setting of print instructions complex. Therefore, to ease a user's burden in navigating and selecting from a plurality of print functions, a technology has been proposed that registers a plurality of settings of print functions as one setting (called “preset setting”) with its name (called “preset setting name”). After selecting a set of print instructions, this technology then stores a preset setting (refer to Japanese Laid-Open Patent Application No. 2002-6693, for example).

However, in such technology, a user must decide the preset setting name that is easy to understand later. This user-decided name must be created and entered manually. Therefore, with the large number of setting combinations possible with modern printers, there is a problem that setting of the preset setting name makes user operation in registering the preset setting complex. Thus, what is desired, as discovered by the present inventors, is an information processing apparatus, computer program product, computer media and method for automatically providing an adjustable name for user-selected image processing functions.

### SUMMARY OF THE INVENTION

According to one aspect of the present invention, an information processing apparatus, computer program product, computer media and method that sets image processing functions and media are provided in which the above-mentioned problems are eliminated at least by way of automatically providing an adjustable name for user-selected image processing functions.

The above aspects of the present invention are achieved by an information processing apparatus, method and computer program product configured to enable a user to set a plurality of image processing functions via one or more screens. Depending on the functions selected, a pre-determined icon is retrieved from a memory. Also, a name corresponding to the selected functions is generated in accordance with a priority scheme which is either predetermined or user-defined. If the name exceeds a predetermined length, the system automatically truncates in accordance with the priority scheme. The name may be edited or replaced with a user-defined name.

### BRIEF DESCRIPTION OF THE DRAWINGS

In the following, embodiments of the present invention will be described with reference to the accompanying drawings.

FIG. 1 is a diagram showing a configuration of a printing system in an embodiment of the present invention;

FIG. 2 is a function block diagram showing a configuration of a terminal in an embodiment of the present invention;

FIG. 3 is a diagram showing an example of usage of a preset setting;

FIG. 4 is a diagram showing setting contents of one preset setting in a preset information management unit;

FIG. 5 is a diagram showing conceptually an example of contents of a print setting in a preset setting;

FIG. 6 is a diagram showing a hardware configuration of a terminal in an embodiment of the present invention;

FIG. 7 is a flowchart to explain a process conducted by a printer driver in registering a preset setting;

FIG. 8 is a diagram showing an example of a screen of a setting dialog;

FIG. 9 is a diagram showing an example of a screen of a finishing sheet in a setting dialog;

FIG. 10 is a diagram showing an example of priority information in a preset information management unit;

FIG. 11 is a diagram showing an example of contents of settings of print functions;

FIG. 12 is a diagram showing an example of a screen of a modifying name of setting dialog;

FIG. 13 is a diagram showing an example of a screen of a printer property dialog in which an icon corresponding to a new preset setting is shown;

FIG. 14 is a diagram showing an example of a screen of an editing priorities dialog;

FIG. 15 is a diagram showing an example of the case that a priority of “two-sided printing” is changed.

### DESCRIPTION OF THE PREFERRED EMBODIMENT

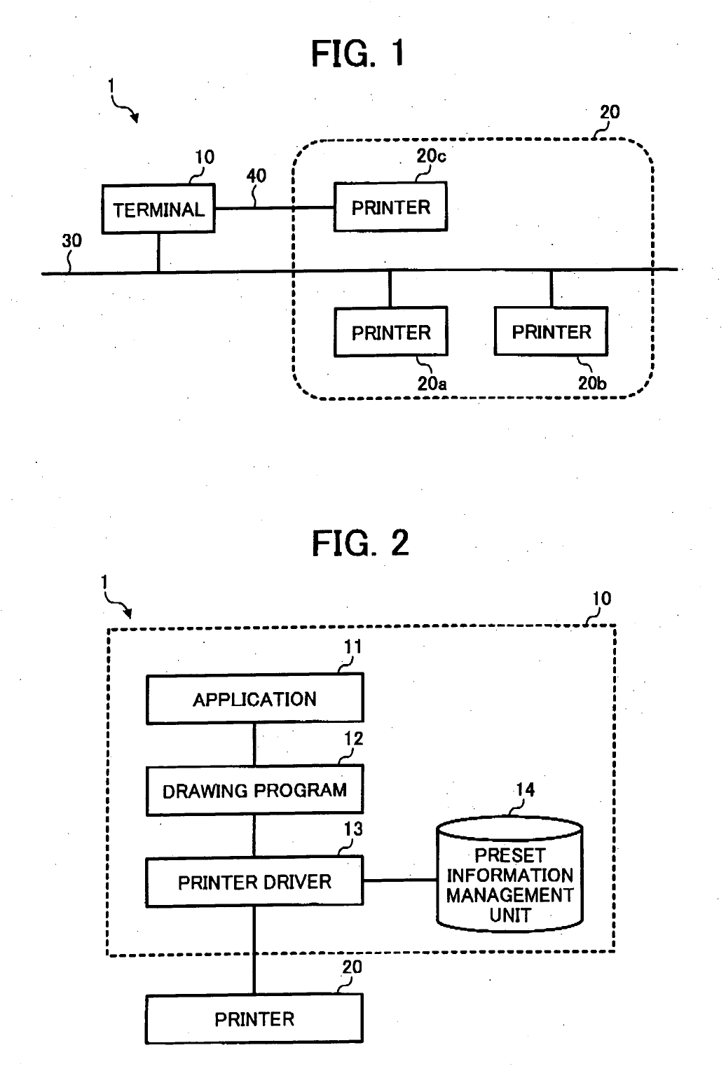

In the following, an embodiment of the present invention will be described with reference to the accompanying drawings. In this embodiment, a printing function will be described as an example of an image processing function. FIG. 1 is a diagram showing an example of a configuration of a printing system in this embodiment. As shown in FIG. 1, the printing system 1 in this embodiment includes a terminal 10, a printer 20a, 20b, 20c (in the following, collectively called “printer 20”).

The printer 20 is a multi-function printer which conducts a printing process according to an instruction from the terminal 10. Additionally, the printer 20a and 20b are connected to the terminal 10 via for example network 30 (regardless of whether it is a fixed line or a wireless line) such as LAN (local area network). The printer 20c is connected to the terminal 10 via for example a cable 40 such as an RS-232C cable or a USB cable.

The terminal 10 is a terminal such as a PC (personal computer), PDA (personal digital (data) assistants) or a mobile phone that a user uses to create document data or to give a print instruction.

FIG. 2 is a diagram showing an example of a functional configuration of the terminal in this embodiment. In FIG. 2, the terminal 10 includes an application 11, a drawing program 12, a printer driver 13 and a preset information management unit 14.

The application 11 is an application such as word processor software or spreadsheet software used for generating information such as document data to be printed by the printer 20. The drawing program 12 is a module that provides the application 11 with functions of drawing that hide the differences of devices such as a printer or a display. When a print instruction is given, the application 11 calls functions of the drawing program 12 so as to convert document data that is peculiar to the application into data in the application-independent data format. The drawing program 12 converts document data into data in the application-independent format according to a function call from the application 11. Then the drawing program 12 calls DDI (device driver interface) functions of the printer driver 13 and output data in the application-independent format to the printer driver 13. Additionally, the drawing program 12 is for example a GDI (graphics device interface) in a WINDOWS environment.

The printer driver 13 is a module that converts data in the application-independent format output by the drawing program 12 into data that can be interpreted by a printer (the printer 20) corresponding to the printer driver 13 (for example, PDL (page description language)). Print data output by the printer driver 13 is sent to the printer 20 via a spooler and a port monitor that are not shown in the diagram.

In the printer driver 13 in this embodiment, when a user gives a print instruction it can be registered as one setting with a name (in the following, called “preset setting”) that setting contents for one or more print functions. Here, print functions are functions that are necessary to be set concerning a print process such as combining printing, two-sided printing, stapling or punching. By registering a preset setting, it is possible for a user to give a print instruction without setting each print function when a user gives a print instruction. A user only selects an appropriate preset setting so as to give a print instruction.

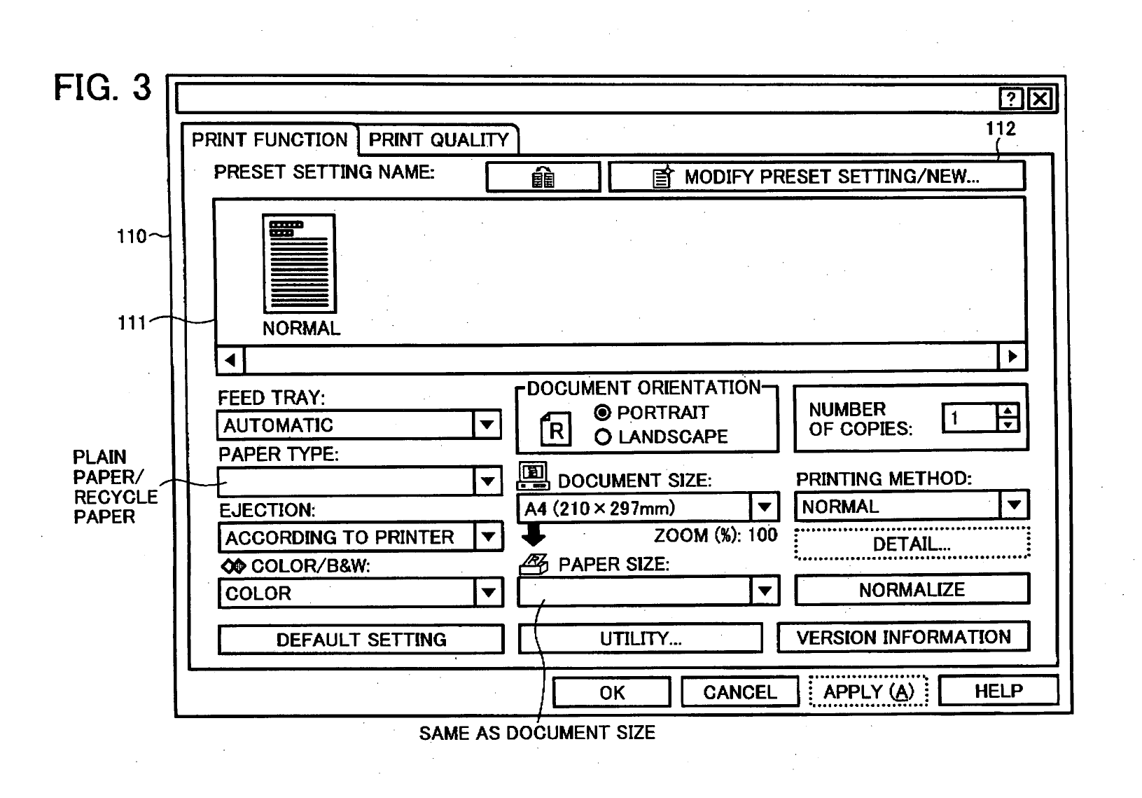

FIG. 3 is a diagram showing an example of usage of the preset setting. A printer property dialog 110 is shown by the printer driver 13 when a “property” button in a print dialog is clicked. The print dialog is shown when a print instruction is given. As symbols indicating print functions, icons are shown in an icon display area 111 in the printer property dialog 110, respectively showing setting contents of preset settings visually. However, in FIG. 3, in the icon display area 111, one preset setting is registered and one icon corresponding to this preset setting is shown. Below each icon in the icon display area 111, a name given to corresponding preset setting is shown (e.g., a “preset setting name”). I In FIG. 3, the preset setting name is “normal”. Here, it is desirable that the preset setting name consists of characters that directly indicate the setting contents of the corresponding preset setting so that a user can easily understand when the user uses the corresponding preset setting.

A user can select a previously defined preset setting for adjustment by browsing/selecting from stored preset settings. The user can browse/select on the base of the designs of the icons in the icon display area 111 or preset setting names below the icons.

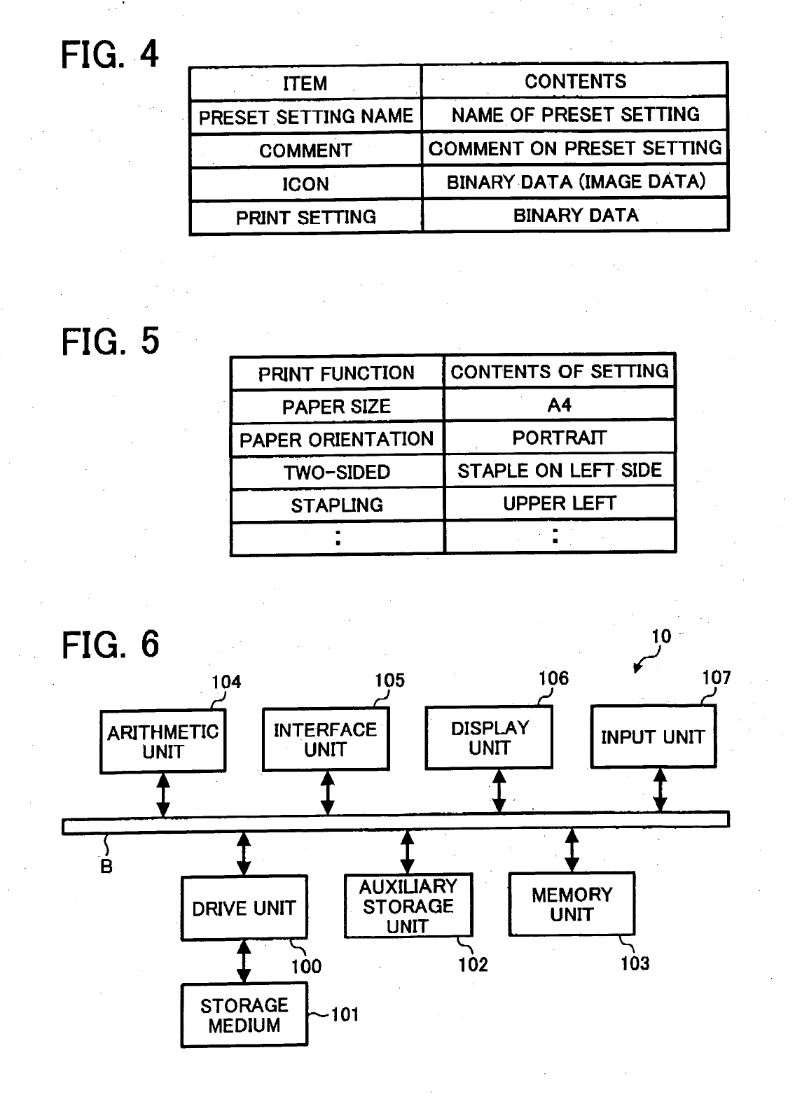

Returning to FIG. 2, setting contents of each preset setting are registered in the preset information management unit 14. FIG. 4 is a diagram showing setting contents of one preset setting in the preset information management unit 14. Each preset setting includes for example a preset setting name, a comment, an icon and a print setting.

When creating a preset setting, the icon is automatically presented by the software on the basis of the settings selected by the user. Also, the name of the preset setting is automatically presented by the software on the basis of the settings selected by the user. The name presented by the software is adjustable by the user. The method by which the software selects and presents a name is described below.

The comment is an optional user-provided explanation of the preset setting. The icon is binary data of the icon that is displayed in the icon display area 111 in the printer property dialog 110 to identify each preset setting as described above. The print setting is binary data that corresponds to parameters for one or more print functions registered by the user as the preset setting. The print setting is for example in a DEVMODE structure in a WINDOWS system.

FIG. 5 is a diagram showing conceptually an example of contents of the print setting in the preset setting. In FIG. 5, contents of the print setting in the preset setting are shown in a table format. As shown in FIG. 5, parameters are registered for each print function. For example in FIG. 5, A4 for paper size, portrait for document orientation, stapling on left side for two-sided printing and upper left for stapling are registered. Moreover parameters for other print functions can be registered, however these are not shown for purposes of convenience.

FIG. 6 is a diagram showing an example of a hardware configuration of the terminal 10 in this embodiment. The terminal 10 in FIG. 6 includes a drive unit 100, an auxiliary storage unit 102, a memory unit 103, an arithmetic unit 104, an interface unit 105, a display unit 106 and an input unit 107, which are connected mutually via a bus B.

Programs realizing functions of the terminal 10 are provided in a storage medium 101 such as CD-ROM. When the storage medium 101 is set in the drive unit 100, the programs are installed in the auxiliary storage unit 102. The auxiliary storage unit 102 stores the programs installed and necessary files or data.

The memory unit 103 reads out the programs from the auxiliary storage unit 102 and stores them when the programs are activated. The arithmetic unit 104 realizes functions of the terminal 10 according to the programs and realizes the application 11, the drawing application 12 and the printer driver 13 or the like in the terminal 10. The interface unit 105 includes for example a modem or a router and is used to connect to the network 30 in FIG. 2. The display unit 106 displays GUI (graphical user interface) or the like according to the programs. The input unit 107 includes a keyboard or a mouse or the like and is used to input various instructions on operations.

Additionally, the installation of the programs is not limited to the installation from the storage medium but the programs may be downloaded from another computer via network 30.

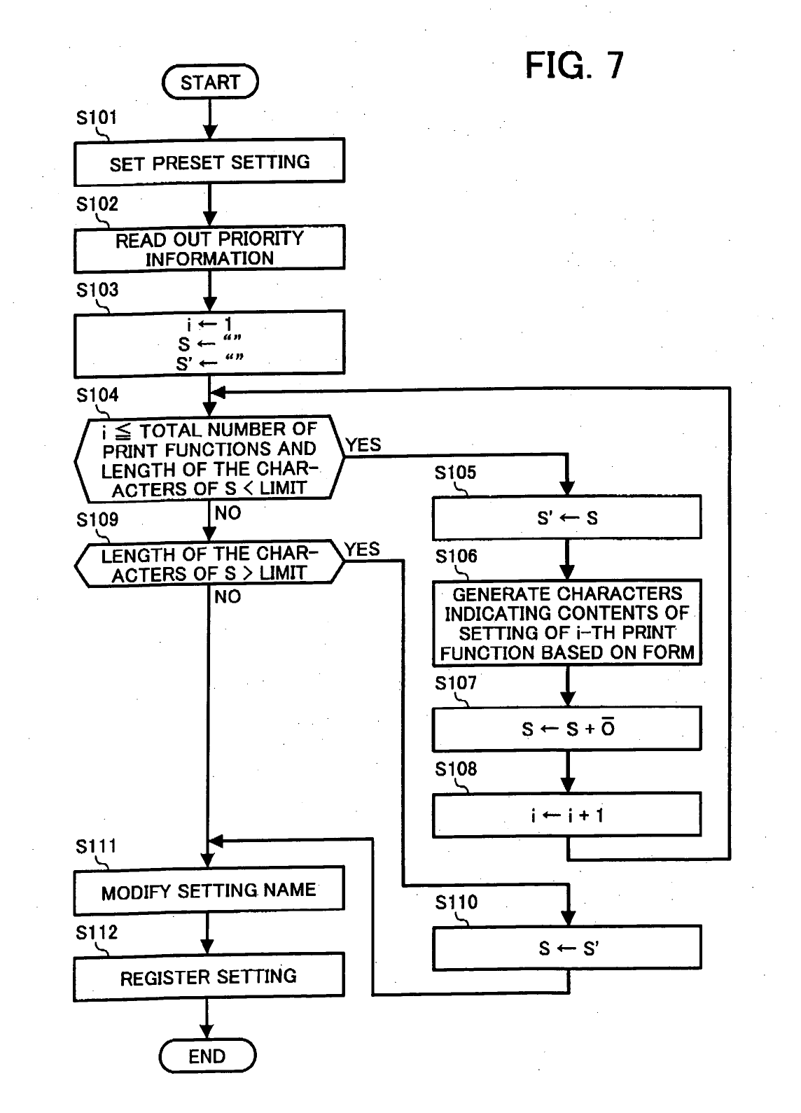

Next, a process of the terminal 10 in FIG. 2 will be described in the following. FIG. 7 is a flowchart that explains a process conducted by the printer driver 13 when a user registers the preset setting.

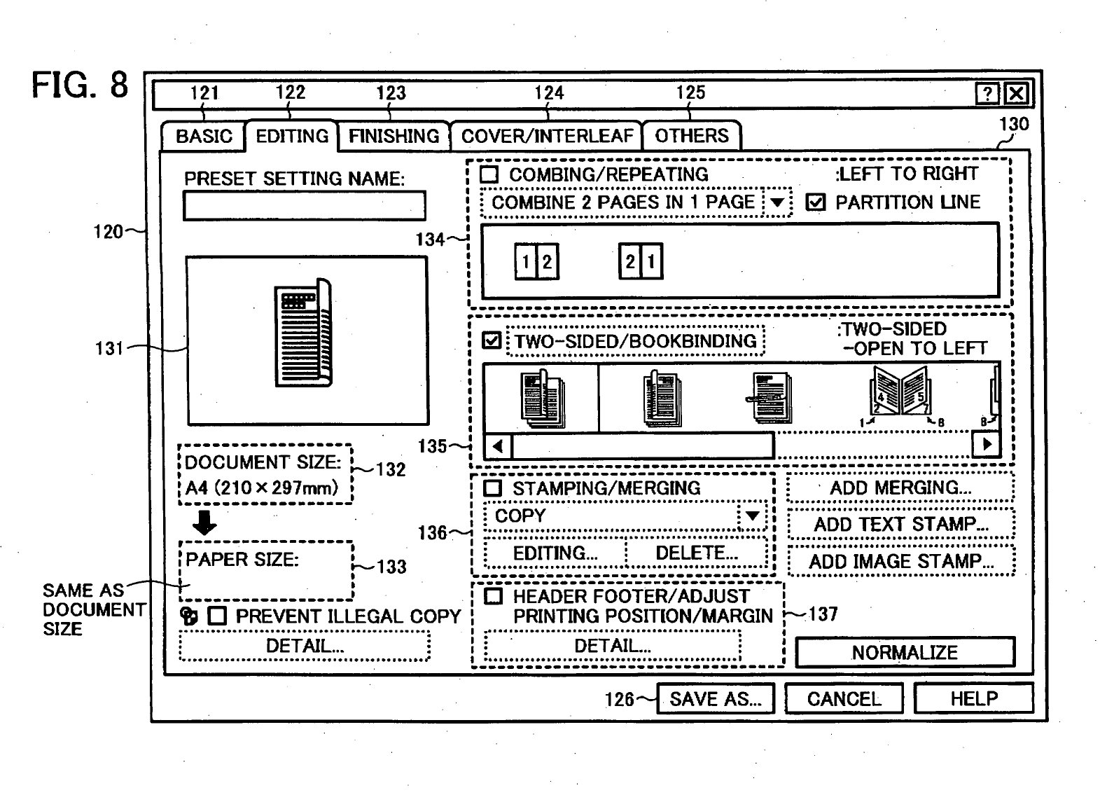

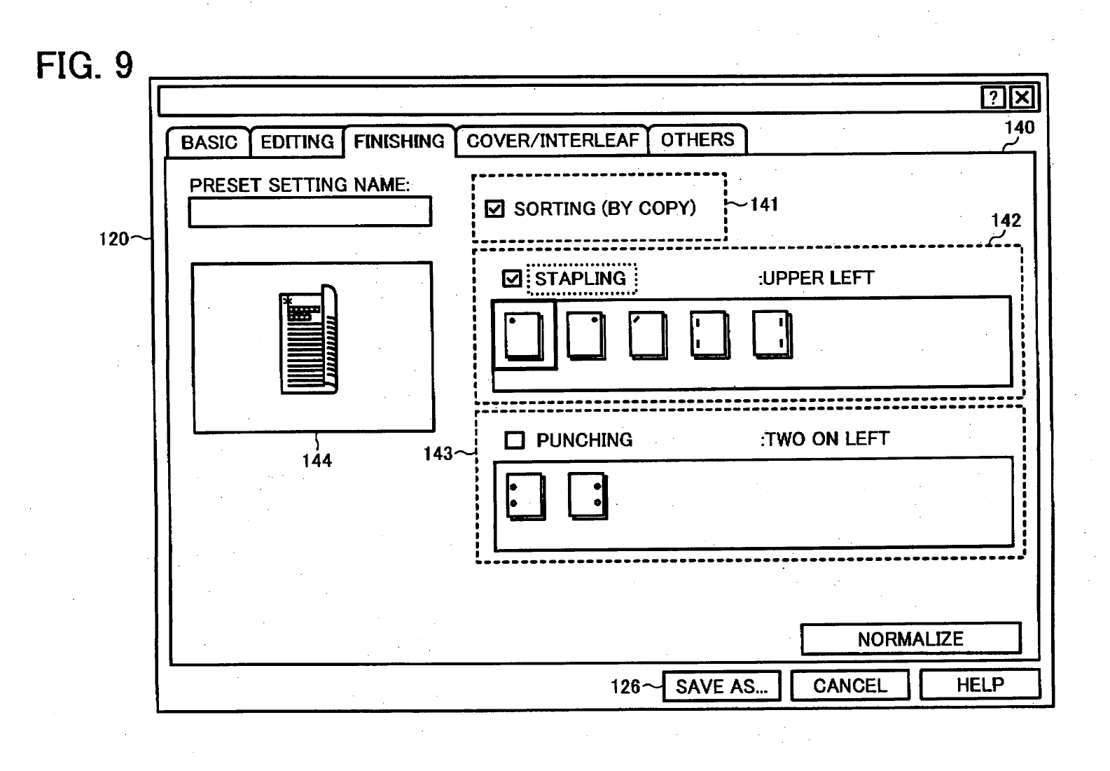

In step S101, a user performs a setting operation for registering a preset setting. This setting operation is performed by inputting settings on print functions such as “document orientation”, “document size”, “paper size” and inputting in dialogs shown in FIG. 8 and FIG. 9 described later or the like. These dialogs are shown when the button 112 in the printer property dialog 110 is clicked.

The “document orientation” is a print function that decides the orientation of print data to be printed. The “document size” is a print function that decides in which size print data are printed. In the case A4 is selected, print data is printed in A4 and in the case A5 is selected, print data is printed in A5. The “paper size” is a print function that decides an actual size of paper where print data are printed. In the case “same as document size” is selected, print data are printed on the paper that is the same size as the “document size”. For example, in the case the “document size” is A4 and the “paper size” is A3, print data are printed on A3 sized paper as an A4 sized image.

In FIG. 3, the setting of the “document size” is A4 and the setting of the “paper size” is “same as document size” therefore print data are printed on A4 sized paper as an A4 sized image.

After setting print functions such as “document orientation”, “document size” and “paper size”, when the button 112 is clicked, a dialog for setting a preset setting (in the following, called “setting dialog”) is shown. FIG. 8 is a diagram showing an example of the setting dialog.

In FIG. 8, the setting dialog 120 includes a plurality of sheets that can be switched by tabs such as a basic tab 121, an editing tab 122, a finishing tab 123, a cover/interleaf tab 124, an others tab 125 and the like so that setting of various print functions are available. In FIG. 8, the editing tab being selected, an editing sheet 130 is shown. In the editing sheet, settings on the form of printing are performed. For example, in area 134 settings on combining printing are available and in area 135, settings on two-sided printing and bookbinding are available. Moreover, in area 136, settings on stamp printing are available and in area 137, settings on a header or footer are available. Here is an example showing “two-sided and open pages leftward” is set in area 135.

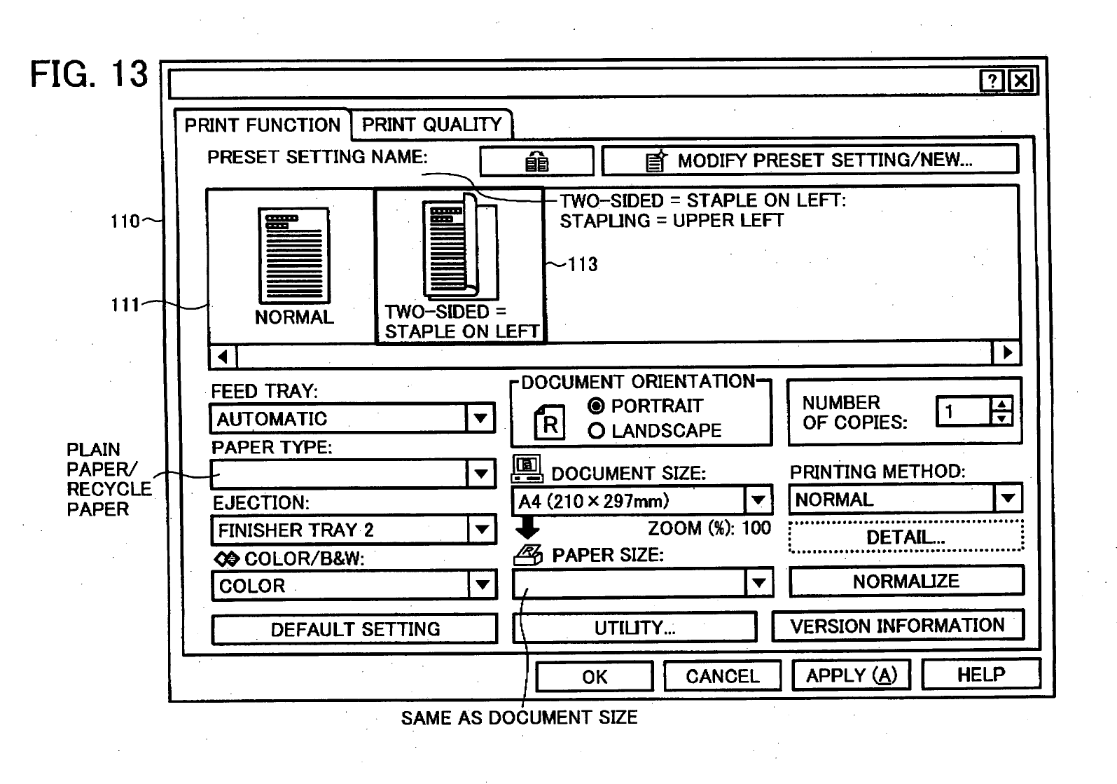

Additionally, in the icon display area 131, icons are shown as symbols indicating print functions. The icons indicate print functions that are set in the printer property dialog 110 shown in FIGS. 3 and 13. In the icon display area 131 of FIG. 8, an example of an icon indicating the “document orientation” is portrait is shown. Moreover, setting parameter on “document size” and “paper size” are respectively shown in area 132 and area 133 of FIG. 8.

Then, when the finishing tab 123 is selected, a finishing sheet is shown. The finishing sheet is for setting on print functions concerning finishing of print data. FIG. 9 is a diagram showing an example of a finishing sheet in the setting diagram. In the finishing sheet 140, settings on print functions such as sorting, stapling and punching are performed respectively in area 141, 142 and 143. In FIG. 9, concerning a print function of stapling, an example of a setting on stapling “upper left” is shown.

Additionally, in the icon display area 144, an icon is shown, indicating settings in the editing sheet 130 and the finishing sheet 14. In FIG. 9, it is shown that an icon indicates settings like “document orientation” is “portrait”, “two-sided printing/bookbinding” is “two-sided and open pages leftward” and “stapling” is “upper left”. The automatically generated icon may indicate all or a part of print functions that are set by the user. When setting of print functions is completed and the button 126 in FIG. 8 or FIG. 9 is clicked, a process advances to step S102 (FIG. 7). In step S102, the printer driver 13 reads out priority information from the preset information management unit 14.

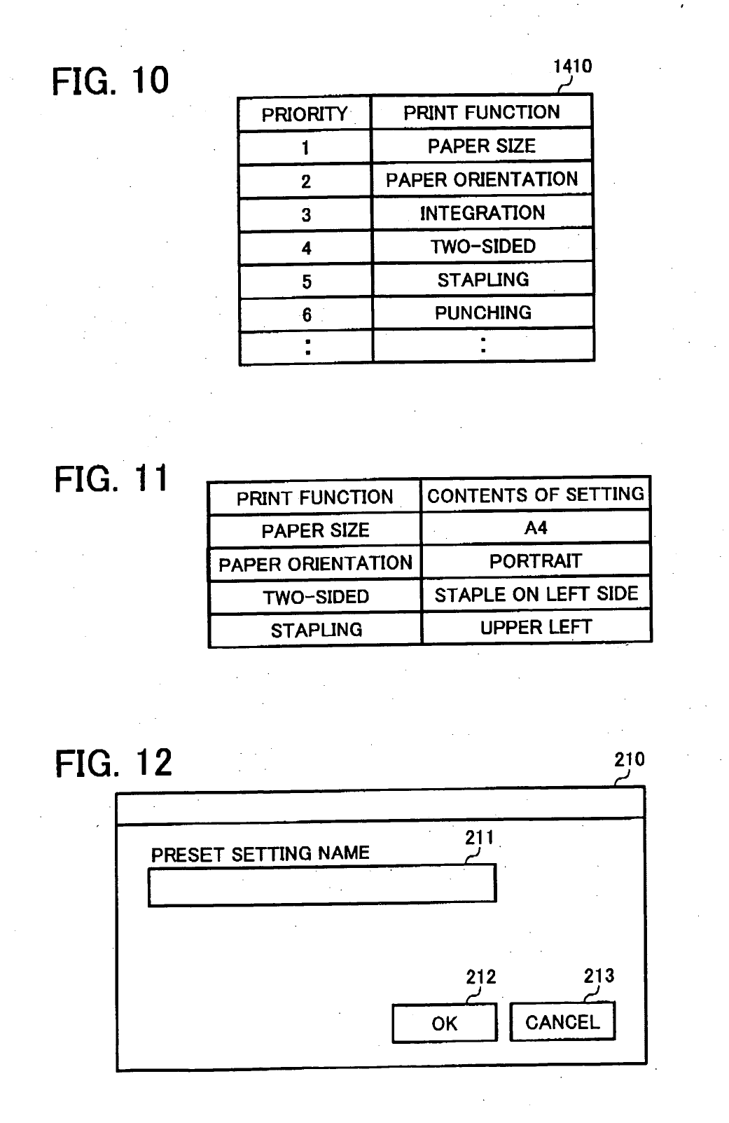

FIG. 10 is a diagram showing an example of the priority information in the preset information management unit 14. As shown in FIG. 10, the priority information 1410 is information defining priorities among print functions and is used for generating a preset setting name automatically by the printer driver 13. These priorities may be predetermined or may be set/adjusted by the user. As described later, the printer driver 13 in this embodiment combines characters indicating setting contents and generates a preset setting name. In this embodiment, characters indicating setting contents are combined according to the priorities. Additionally, in FIG. 10, though the priorities are shown up to sixth, all the print functions have priorities and the rest of the priorities are not shown for purposes of convenience.

Returning to FIG. 7, the process advances from step S102 to step S103 and the printer driver 13 performs initialization of variables used in a loop for each print function. A variable i is a variable to specify a print function that is an object of processing at present and is initialized to “1”. Additionally, print functions become an object of processing according to the priority information 141. Accordingly, in the following, the “i-th print function” has the same meaning as the print function that is in the i-th priority. A variable S is a variable that represents a preset setting name and is initialized to null (“ ”). A variable S′ is a variable to reserve contents of variable S and is initialized to null (“ ”) as well as the variable S.

The process advances from step S103 to step S104 and the printer driver 13 decides whether i is smaller than the total number of print functions or not (that is, process is completed for all the print functions or not). And the printer driver 13 decides whether the length of the characters of the preset setting name is shorter than the predetermined limit. If both conditions are satisfied, the process advances to step S105 and the printer driver 13 saves the value of the variable S in the variable S′.

The process advances from step S105 to step S106 and the printer driver 13 applies a prescribed form to contents of settings of the i-th print function so as to generate characters indicating contents of settings of the i-th print function. And the printer driver 13 substitutes generated characters to a variable O.

Here, as the prescribed form of characters indicating contents of settings of print functions, for example, “<name of print function>=<parameter>:” may be applied. For example, if A4 is set for “paper size”, the characters become “paper size=A4:”. Additionally, omitting “name of print function”, the characters including only parameters may be applied.

The process advances from step S106 to step S107 and the printer driver 13 optionally substitutes contents of the variable O (the characters indicating the contents of the settings of i-th print function) to the variable S.

Moreover, it is noted that the characters indicating the contents of the settings of the i-th print function are not contained in the variable S′ at this point. That is, characters indicating the contents of the settings of the (i−1)th (previous) print function are contained in the variable S′.

The process advances from step S107 to step S108 and the printer driver 13 make the variable i increment by 1 so as to make the print function in the next priority become an object of processing in step S104 and the following.

In step S104, if it is determined that all the print functions are completed or if it is determined that the length of the characters of the preset setting name in the variable S′ is longer than the predetermined limit, the process escapes from the loop and advances to step S109. In step S109, the printer driver 13 determines whether the length of the characters of the preset setting name in the variable S′ is longer than the predetermined limit or not. If it is determined that the length of the characters of the preset setting name in the variable S′ is longer, the process advances to step S110. In step S110, the printer driver 13 substitutes the parameter in the variable S′ to the variable S. That is, the parameter in the variable S′ is the characters indicating print functions up to the previous print function, which are not longer than the predetermined limit.

Here, using a concrete example, it is explained how to generate the preset setting name in the above process. FIG. 11 is a diagram showing an example of contents of settings of print functions in an embodiment of the present invention. As shown in FIG. 11, here, “A4” for “document size”, “portrait” for “document orientation”, “staple on left side” for “two-sided print” and “upper left” for “stapling” are set. In this embodiment, print functions without setting are not processed. For example, in FIG. 11, combining print or punching is not set. Additionally, the priorities of print functions are the same as in FIG. 10. Moreover, a limit of the preset setting name is 80 characters.

In the above case, by repeating steps from step S104 to step S109 in FIG. 7, the parameter in the variable S changes as following.

(1) document size=A4:

(2) document size=A4: document orientation=portrait:

(3) document size=A4: document orientation=portrait: two-sided=staple on left side:

(4) document size=A4: document orientation=portrait: two-sided=staple on left side: stapling=upper left:

The process escapes from the loop in the state of (4), however because the length of the characters in (4) is longer than 80 characters, in step S110, the characters in (3) are used for the preset setting name.

If it is NO in step S110 or in step S109 (the length of the characters of the preset setting name is not longer than the predetermined limit), the process advances to step S111. In step S111, the printer driver 13 makes a dialog for modifying the preset setting name (in the following, called “modifying name of setting dialog”) shown on the screen.

FIG. 12 is a diagram showing an example of a screen of the modifying name of setting dialog. In FIG. 12, the modifying name of setting dialog 210 includes inputting name of the setting area 211, an OK button 212, a cancel button 213 and the like. In the inputting name of setting area 211, the preset setting name is shown that is automatically generated in steps from step S101 to step S110. A user is able to modify the preset setting name arbitrarily, with a mouse, a keyboard or the like, by editing the preset setting name shown in inputting name of the setting area 211. For example, in the case the contents of the setting are the same as in FIG. 11, as the preset setting name, characters “document size=A4: document orientation=portrait: two-sided=staple on left side” are shown in the inputting name of setting area 211. Then if a user modifies the preset setting name by deleting the characters “document size”, “document orientation” and “two-sided”, the preset setting name becomes the characters “A4: portrait: staple on left side:”. Then if an OK button is clicked, step S112 is performed and the characters “A4: portrait: staple on left side:” is registered as the preset setting name. Additionally, step S111 is not necessary to be performed.

In step S112, the printer driver 13 associates the contents of the settings set in the setting dialog 120 with the generated the preset setting name and registers them in the preset information management unit 14 (FIG. 4). Then the printer driver 13 makes an icon registered in a new entry shown in the printer property dialog 110 and ends the process.

FIG. 13 is a diagram showing an example of a screen of the printer property dialog 110 where an icon corresponding to a new preset setting is shown. An icon 113 in an icon display area 111 is a icon corresponding to the new preset setting.

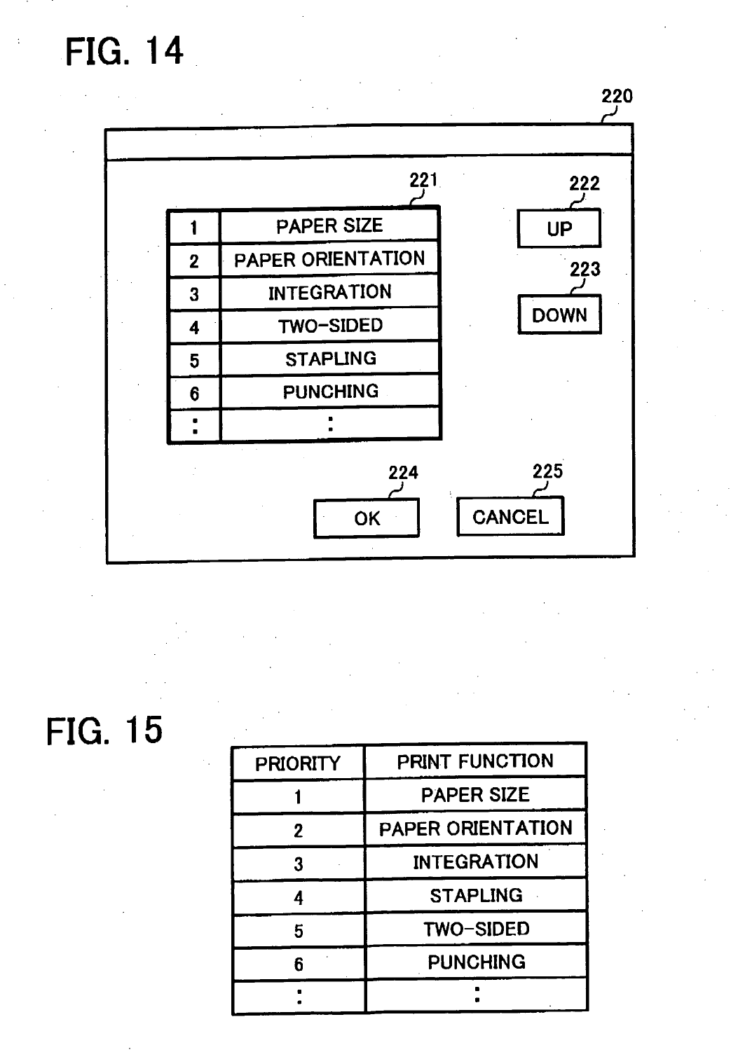

Moreover, as an additional function, a dialog for modifying the priority information 141 (FIG. 10) (in the following, called “modifying priories dialog”) may be applied. This dialog may be shown according to a user operation such as selection from a pull-down menu. FIG. 14 is a diagram showing an example of a screen of the modifying priorities dialog. In FIG. 14, the modifying priorities information 220 includes a priorities display area 221, an up button 222, a down button 223, an OK button 224, a cancel button 225 and the like.

In the priorities display area 221, priorities set at present are shown and a user can select a print function priority to be modified. The up button 222 and the down button 223 is buttons for moving upward or downward the priority selected in the priorities display area 221. For example, if an entry “two-sided printing” is selected and the down button 223 is clicked once, the priorities are changed like FIG. 15.

FIG. 15 is a diagram showing an example of the case that a priority of “two-sided printing” is changed. As shown in FIG. 15, the priority of “two-sided printing” is dropped by one and accordingly the priority of “stapling” is raised by one. If the OK button 224 in the modifying priorities dialog 223 is clicked in this state, the priority information in FIG. 15 is registered in the preset information management unit 14. Additionally, in FIG. 14 and FIG. 15, priorities are shown up to sixth, however the rest of the priorities are not shown for purposes of convenience as well as FIG. 10.

As described above, the terminal 10 in this embodiment generates a preset setting name automatically so that user operations in registering the preset can be easier. Additionally, the preset setting name is generated according to the priorities among print functions therefore the preset setting name is generated based on print functions in high priorities. Therefore the preset setting name easier to understand is generated and usability improves. Moreover, the modifying name of setting dialog 210 enable a user to modify the preset setting name automatically generated so that a user can register a the preset setting name of his or her choice.

Additionally, in this embodiment, a print function is explained as a concrete example of an image processing function. However, the present invention is not limited to only print function but also may be applied to other image processing functions such as a scanner function, a facsimile function or a like. For example, in order to use a scanner function, a user needs settings such as a resolution, color or black, two-sided or single-sided, a data format of scanned data or the like. That is, in order to use a facsimile function, a user needs settings such as send by memory or send directly, color or black, addresses or the like. In registering these settings as a preset setting, the method described in this embodiment may be applied to generate automatically the preset setting name.

Moreover, in this embodiment, an example that the printer driver 13 conducts a process shown in FIG. 7 is explained as a concrete example. However, for example, the application 11 may conduct this process. For example, in a WINDOWS system, the application 11 and the printer driver 13 can communicate contents of settings of print functions in the format of a DEVMODE structure. Accordingly, the application 11 may notify the contents of settings of print functions to the printer driver 13 in the format of the DEVMODE so as to register the contents of settings.

The present invention is not limited to the specifically disclosed embodiments, and variations and modifications may be made without departing from the scope of the present invention.

The present application is based on the Japanese Priority Applications No. 2004-347043 filed on Nov. 30, 2004 and No. 2005-338558, filed on Nov. 24, 2005, the entire contents of which are hereby incorporated by reference.

What is claimed is:

1. An information apparatus configured to set a plurality of image processing functions, comprising:
a name generating part configured to automatically generate a name of a symbol corresponding to image processing function settings selected from said plurality of image processing functions by a user and set by said user in a display;
a registering part configured to associate said automatically generated name with said image processing function settings set by said user; and
a display configured to display said symbol and said automatically generated name.

2. The information processing apparatus as claimed in claim 1, further comprising:
a recording part configured to record said symbol and said automatically generated name to a stored list of available symbols and corresponding image processing function settings.

3. The information processing apparatus as claimed in claim 1, wherein the name generating part is configured to automatically generate said name by combining characters corresponding to each of said plurality of image processing functions selected and set by said user in said display.

4. The information processing apparatus as claimed in claim 1, wherein the name automatically generated has a predetermined maximum length of characters.

5. The information processing apparatus as claimed in claim 1, wherein the name generating part comprises:
a name modifying part configured to enable a user to modify said automatically generated name.

6. The information processing apparatus as claimed in claim 2, further comprising:
a priority information storing part configured to store priority information indicating a priority of at least a subset of said plurality of image processing functions,
wherein the name generating part is configured to automatically generate said name according to said priority information.

7. The information processing apparatus as claimed in claim 6, wherein said priority information storing part comprises:
a priority information adjustment part configured to enable a user to view and adjust said priority information.

8. A method of controlling an information apparatus configured to set a plurality of image processing functions, comprising:
automatically generating a name of a symbol corresponding to image processing function settings selected from said plurality of image processing functions by a user and set by said user in a display;
associating said automatically generated name with said image processing function settings set by said user; and
displaying said symbol and said automatically generated name.

9. The method as claimed in claim 8, further comprising:
recording said symbol and said automatically generated name to a stored list of available symbols and corresponding image processing function settings.

10. The method as claimed in claim 8, wherein said step of automatically generating comprises:
automatically generating said name by combining characters corresponding to each of said plurality of image processing functions selected and set by said user in said display.

11. The method as claimed in claim 8, wherein the name automatically generated has a predetermined maximum length of characters.

12. The method as claimed in claim 8, wherein said step of automatically generating comprises comprises:
enabling a user to modify said automatically generated name.

13. The method as claimed in claim 9, further comprising:
storing priority information indicating a priority of at least a subset of said plurality of image processing functions,
wherein the step of automatically generating said name includes automatically generating said name according to said priority information.

14. The method as claimed in claim 13, wherein said step of storing priority information comprises:
enabling a user to view and adjust said priority information.

15. A computer program product including instructions configured to cause a computer device to execute the method as recited in one of claims 8-14.
